(19) United States
(12) Patent Application Publication
(10) Pub. No.: US 2026/0063076 A1
(43) Pub. Date: Mar. 5, 2026

(54) GAS TURBINE ENGINE HAVING A MECHANICAL POWER SHARING ARRANGEMENT

(71) Applicants: General Electric Company, Cincinnati, OH (US); GE Avio S.r.l., Rivalta di Torino (IT)

(72) Inventors: Brandon Wayne Miller, Middletown, OH (US); Andrew Gumpert, West Chester, OH (US); Andrew Hudecki, Milford, OH (US); Ryan T. Roehm, West Chester, OH (US); Vincenzo Martina, Alpignano (IT)

(21) Appl. No.: 18/822,908

(22) Filed: Sep. 3, 2024

(51) Int. Cl. F02C 7/32; F02C 7/36

(52) U.S. Cl. CPC F02C 7/32; F02C 7/36; F05D 2260/4031

(57) ABSTRACT

A gas turbine engine includes a low pressure spool that connects a low pressure compressor to a low pressure turbine. The gas turbine engine further includes a high pressure spool that connects a high pressure compressor to a high pressure turbine. The gas turbine engine further includes a high pressure geartrain that is coupled in gear with the high pressure spool. The gas turbine engine further includes a low pressure geartrain that is coupled in gear with the low pressure spool. The gas turbine engine further includes an accessory gearbox that has an accessory drive gear that is selectively drivingly coupled at least one of the high pressure geartrain and the low pressure geartrain.

### FIELD

The present disclosure relates to a gas turbine engine having mechanical power sharing arrangement.

### BACKGROUND

A gas turbine engine generally includes a turbomachine and a rotor assembly. The rotor assembly may include a low pressure spool and a high pressure spool. The low pressure spool connects a low pressure compressor and a low pressure turbine, and the high pressure spool connects a high pressure compressor and a high pressure turbine. The high pressure spool and the low pressure spool may co-rotate or counter rotate at different speeds. It is advantageous in many operating scenarios to transfer power between the low pressure spool and the high pressure spool. This has traditionally been done using hybrid-electric propulsion systems having electric machines that transfer power between the spools. A mechanical power sharing arrangement capable of transferring power between the high pressure spool and the low pressure spool at various operating conditions would be welcome and appreciated in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a cross-sectional view of a gas turbine engine in accordance with an exemplary aspect of the present disclosure;

FIG. 2 illustrates a cross-sectional view of a compressor section of a gas turbine engine in accordance with embodiments of the present disclosure;

FIG. 3 illustrates a cross-sectional view of a compressor section of a gas turbine engine in accordance with embodiments of the present disclosure.

FIG. 4 illustrates a schematic view of a mechanical power sharing arrangement in accordance with embodiments of the present disclosure;

FIG. 5A illustrates a side view of a continuous variable transmission in a first position in accordance with exemplary aspects of the present disclosure;

FIG. 5B illustrates a side view of the continuous variable transmission shown in FIG. 5A in a second position in accordance with exemplary aspects of the present disclosure;

FIG. 6 illustrates a schematic view of a mechanical power sharing arrangement in accordance with embodiments of the present disclosure;

FIG. 7 illustrates a schematic view of a mechanical power sharing arrangement in accordance with embodiments of the present disclosure;

FIG. 8 illustrates a schematic view of a mechanical power sharing arrangement in accordance with embodiments of the present disclosure;

FIG. 9 illustrates a schematic view of a mechanical power sharing arrangement in accordance with embodiments of the present disclosure;

FIG. 10 illustrates a schematic view of a mechanical power sharing arrangement in accordance with embodiments of the present disclosure;

FIG. 11 illustrates a schematic view of a mechanical power sharing arrangement in accordance with embodiments of the present disclosure;

FIG. 12 illustrates a schematic view of a mechanical power sharing arrangement in accordance with embodiments of the present disclosure;

FIG. 13 illustrates a schematic view of a mechanical power sharing arrangement in accordance with embodiments of the present disclosure;

FIG. 14 illustrates a flow chart of a method of operating a gas turbine engine in accordance with embodiments of the present disclosure;

FIG. 15 illustrates a flow chart of a method of operating a gas turbine engine in accordance with embodiments of the present disclosure; and

FIG. 16 provides a block diagram of a controller for implementing one or more aspects of the present disclosure according to example embodiments of the present disclosure.

### DETAILED DESCRIPTION

Reference now will be made in detail to embodiments of the gas turbine engines, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents

The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component, and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values, and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” refers to an inclusive selection and not to an exclusive selection. For example, a condition A and/or B is satisfied by any one of the following: A is true (or present) and B is false (or not present), A is false (or not present) and B is true (or present), and both A and B are true (or present).

The phrase “proximate to” refers to being closer to one end or component than an opposite end or component. For example, when used in conjunction with first and second ends; high pressure and low pressure sides; leading edge and trailing edge; or the like, the phrase “proximate to the first end,” or “proximate to the high pressure side,” refers to a location closer to the first end than the second end, or closer to the high pressure side than the low pressure side, respectively. When used in conjunction with a component, the phrase “proximate the high pressure bearing” may refer to the element being closer to the high pressure bearing than the low pressure bearing.

The present disclosure is generally related to a mechanical power sharing arrangement for a gas turbine engine. The mechanical power sharing arrangement includes a low pressure geartrain coupled to a low pressure spool and a high pressure geartrain coupled to a high pressure spool. The high pressure geartrain may be coupled to the high pressure spool and the low pressure geartrain may be coupled to the low pressure spool at a common axial location and within a shared oil sump, which advantageously prevents the need for two separate sumps for each geartrain. Additionally, the high pressure geartrain and the low pressure geartrain may be disposed at different circumferential locations. In some embodiments, the high pressure geartrain and the low pressure geartrain may cross the flowpath through a common frame (e.g., the compressor framing).

The low pressure geartrain and the high pressure geartrain may be coupled to one another via a power transfer device. The power transfer device may be a continuous variable transmission, a pneumatic system, a hydraulic system and/or a mechanical system, e.g., a clutch (friction or sprag type being a couple examples). In other embodiments, the low pressure geartrain and the high pressure geartrain may be coupled to one another via an accessory gearbox. In embodiments featuring a power transfer device, power may be transferred directly between the high pressure spool and the low pressure spool via the power transfer device. By contrast, in embodiments featuring an accessory gearbox connection, power may be drawn from the high pressure spool and/or the low pressure spool and used for driving an accessory via the accessory gearbox, or the power may be transferred between the high pressure spool and the low pressure spool across multiple accessories in the accessory gearbox.

Additionally, the mechanical power sharing arrangement may include one or more clutches for selectively decoupling the geartrains from the respective spools. For example, a high pressure clutch may selectively decouple the high pressure spool from the high pressure geartrain depending on operating conditions. Similarly, a low pressure clutch may selectively decouple the low pressure spool from the low pressure geartrain depending on operating conditions.

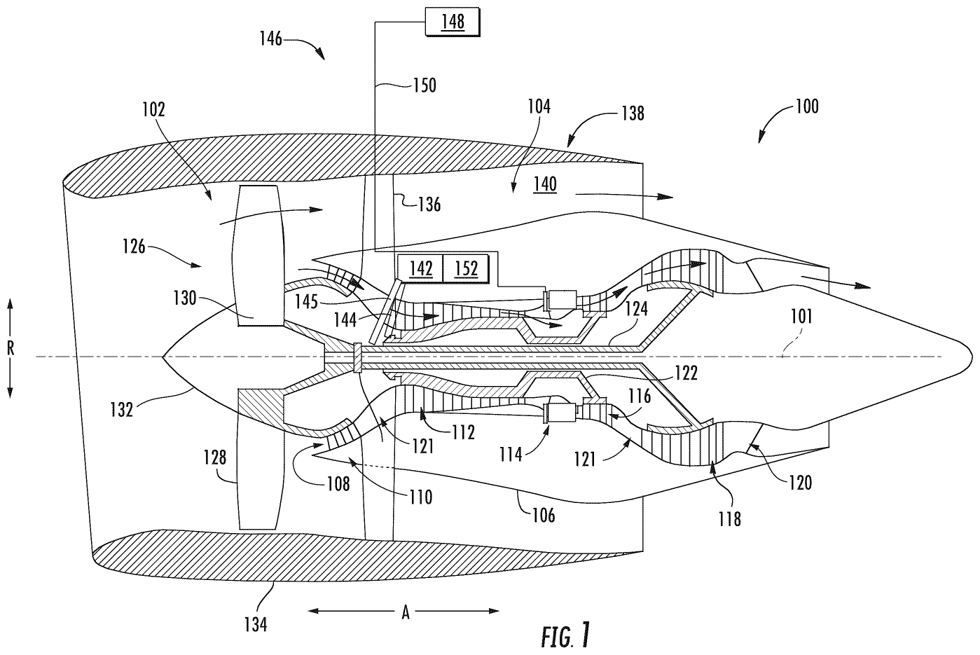

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the gas turbine engine 100 is configured as a high bypass turbofan engine. As shown in FIG. 1, the gas turbine engine 100 defines an axial direction A (extending parallel to a centerline axis 101 provided for reference), a radial direction R, and a circumferential direction (extending about the axial direction A; not depicted in FIG. 1). In general, the gas turbine engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet exhaust nozzle section 120. The gas turbine engine 100 further includes one or more drive shafts. More specifically, the gas turbine engine 100 includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP spool 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that gas turbine engine 100 generally includes a first stream (e.g., core air flowpath 121) and a second stream (e.g., bypass airflow passage 140) extending parallel to the first stream. In certain exemplary embodiments, the gas turbine engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the gas turbine engine 100 additionally includes an output device 142 (such as a power transfer device and/or an accessory gearbox). For the embodiment shown, the output device 142 is located within the outer casing 106 of the turbomachine 104. Additionally, it will be appreciated that for the embodiment depicted schematically in FIG. 1, the output device 142 is mechanically coupled to, and rotatable with, one or more shafts or spools of the turbomachine 104. For example, in the exemplary embodiment depicted, the output device 142 is mechanically coupled to, and rotatable with, the HP spool 122 through a high pressure geartrain 144. Similarly, the output device 142 may be mechanically coupled to, and rotatable with, the LP spool 124 through a low pressure geartrain 145. In embodiments in which the output device is an accessory gearbox, the accessory gearbox may provide power to one or more suitable accessory systems of the gas turbine engine 100 during at least certain operations, and may further provide power back to the gas turbine engine 100 during other operations. For example, the accessory gearbox is, for the embodiment depicted, coupled to an air turbine starter (ATS) 152. The ATS 152 may be configured to extract power from the accessory gearbox and gas turbine engine 100 during certain operation to generate electrical power, and may provide power back to the accessory gearbox and gas turbine engine 100 (e.g., to the HP spool 122) during other operations to add mechanical work back to the gas turbine engine 100 (e.g., for starting the gas turbine engine 100). In embodiments in which the output device 142 is a power transfer device, the power transfer device may transfer power between the HP spool 122 and the LP spool 124 via the geartrains 144, 145 (e.g., to decelerate one spool and accelerate the other, or vice versa).

The gas turbine engine 100 may further include a fuel delivery system 146. The fuel delivery system 146 may be an aircraft fuel supply, such as an aircraft fuel supply for a propulsion system for an aircraft. The fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the gas turbine engine 100.

It will be appreciated, however, that the exemplary gas turbine engine 100 depicted in FIG. 1 is provided by way of example only. In other exemplary embodiments, any other suitable gas turbine engine may be utilized with aspects of the present disclosure. For example, in other embodiments, the gas turbine engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP spool 124), may be a variable pitch gas turbine engine (i.e., including a fan 126 having a plurality of fan blades 128 rotatable about their respective pitch axes), etc. Moreover, although the exemplary gas turbine engine 100 includes a ducted fan 126, in other exemplary aspects, the gas turbine engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

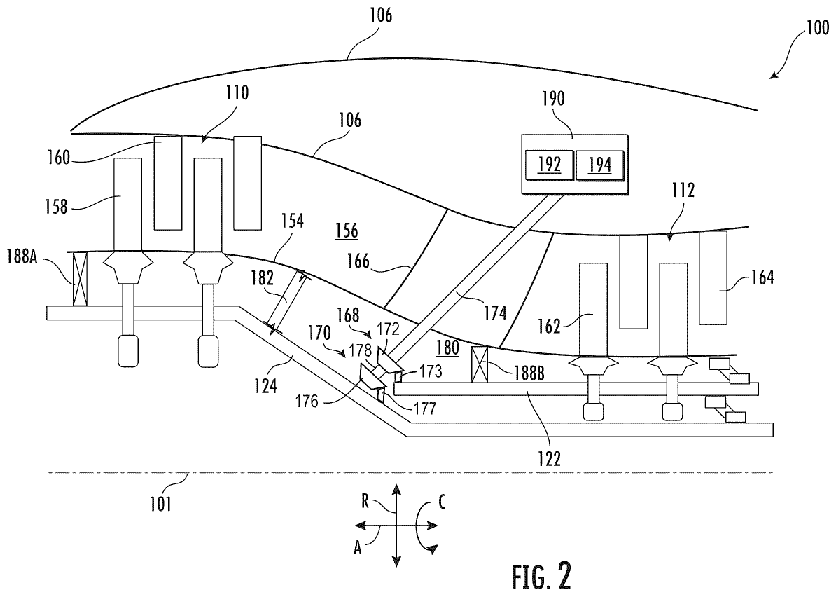

Referring now to FIG. 2, a cross-sectional enlarged view of a compressor section of the gas turbine engine 100 is illustrated in accordance with embodiments of the present disclosure. As shown, the gas turbine engine 100 may extend along the centerline axis 101, along which a cylindrical coordinate system is defined. The cylindrical coordinate system includes an axial direction A, a radial direction R, and a circumferential direction C. The outer casing 106 surrounds or encases the compressor section and one or more spools. As shown, the low pressure spool 124 connects the low pressure compressor 110 and the low pressure turbine 118 (shown in FIG. 1). Similarly, the high pressure spool 122 connects the high pressure compressor 112 and the high pressure turbine 116 (shown in FIG. 1).

The gas turbine engine 100 includes an inner duct 154. The outer casing 106 and the inner duct 154 define a core air flowpath 156. The low pressure compressor 110 includes low pressure rotor blades 158 and low pressure stator vanes 160 extending within the core air flowpath 156. The low pressure rotor blades 158 are coupled to the low pressure spool 124, and the low pressure stator vanes 160 are be coupled to a stationary frame of the gas turbine engine 100 (such as the outer casing 106 or other stationary frame). The high pressure compressor 112 includes high pressure rotor blades 162 and high pressure stator vanes 164 extending within the core air flowpath 156 downstream of the low pressure compressor 110. The high pressure rotor blades 162 are coupled to the high pressure spool 122, and the high pressure stator vanes 164 are coupled to a stationary frame of the gas turbine engine 100 (such as the outer casing 106 or other stationary frame).

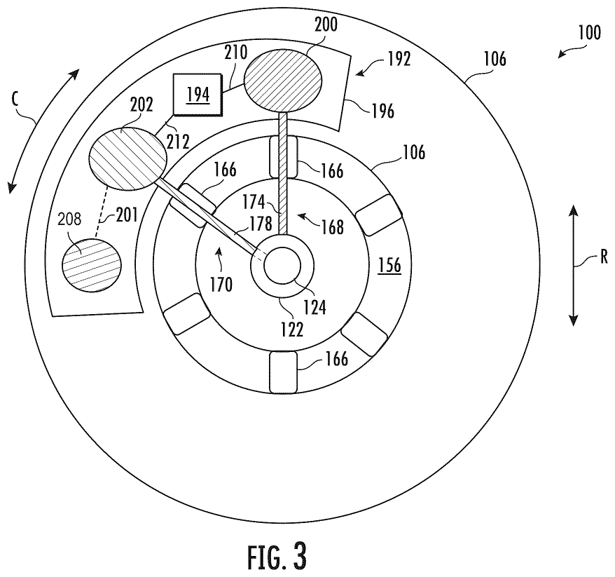

In many embodiments, as shown, a plurality of struts 166 (only one of which is shown in FIG. 2) extend within the core air flowpath 156 between the inner duct 154 and the outer casing 106. The plurality of struts 166 may be circumferentially spaced apart from one another (as shown in FIG. 3). The plurality of struts 166 are stationary, such that they do not rotate within the core air flowpath 156. The struts 166 are generally aerodynamically shaped (such as shaped like an airfoil) and extend through the core air flowpath 156 to provide additional structural integrity to the gas turbine engine 100.

In exemplary embodiments, the gas turbine engine 100 includes a high pressure geartrain 168 and a low pressure geartrain 170. The high pressure geartrain 168 is coupled in gear with the high pressure spool 122, such that the high pressure geartrain 168 rotates with and is powered by the high pressure spool 122. Similarly, the low pressure geartrain 170 is coupled in gear with the low pressure spool 124, such that the low pressure geartrain 170 rotates with and is powered by the low pressure spool 124.

In exemplary embodiments, the high pressure spool 122 and low pressure spool 124 are supported by a plurality of bearing assemblies or thrust bearings 188A, 188B (only two of which are shown) relative to one or more stationary structures of the gas turbine engine 100. For example, as shown in FIG. 2, a high pressure bearing assembly 188B is disposed proximate the high pressure compressor 112 and coupled to the high pressure spool 122. The high pressure bearing assembly is disposed between (e.g., axially between) the geartrains 168, 170 and the high pressure compressor 112. That is, the high pressure bearing assembly 188B is disposed immediately (or directly) aft of the high pressure geartrain 168 and the low pressure geartrain 170 and forward of the high pressure compressor 112. The high pressure bearing assembly 188B is coupled to both the high pressure spool 122 and a stationary frame of the gas turbine engine 100 (such as the inner duct 154). Similarly, a low pressure bearing assembly 188A is disposed proximate the low pressure compressor 110 and coupled to the low pressure spool 124. That is, the low pressure bearing assembly 188A is disposed forward of the low pressure compressor 110. The low pressure bearing assembly 188A is coupled to the low pressure spool 124 and a stationary frame of the gas turbine engine 100 (such as the inner duct 154).

In various embodiments, the high pressure geartrain 168 and the low pressure geartrain 170 are disposed proximate the high pressure bearing 188B (e.g., closer to the high pressure bearing 188B than the low pressure bearing 188A). Positioning the high pressure geartrain 168 and the low pressure geartrain 170 adjacent and in close proximity to at least one bearing assembly (e.g., the high pressure bearing 188B) advantageously allows for the components to share a common sump 180 (as described in more detail below). Additionally, positioning the high pressure geartrain 168 and the low pressure geartrain 170 adjacent and in close proximity to at least one bearing assembly (e.g., the high pressure bearing 188B) advantageously reduces stress on the high pressure bearing 188B due to thermal growth/contraction of the geartrains 168, 170.

In many embodiments, the gas turbine engine 100 includes a sump 180 (such as an oil wetted sump), which is defined at least partially by one or more of the high pressure spool 122, the low pressure spool 124, the inner duct 154, and one or more sealing members 182. The sealing members 182 may include seals at one or both ends (such as labyrinth seals or other seals). The sump 180 may contain a lubrication oil for the bearing assemblies 188, the spools 122, 124, the high pressure geartrain 168, and the low pressure geartrain 170. That is, at least one bearing assembly 188B, the spools 122, 124, and the geartrains 168, 170 are each be at least partially disposed in the sump 180.

The high pressure geartrain 168 includes a high pressure gear 172 and a high pressure shaft 174 coupled to the high pressure gear 172. The high pressure gear 172 is coupled in gear with the high pressure spool 122 and disposed within the sump 180, and the high pressure shaft 174 may extend from the high pressure gear 172 out of the sump 180. That is, the high pressure shaft 174 rotates with and couples to the high pressure gear 172. For example, the high pressure gear 172 is be meshed or engaged with high pressure gear teeth 173 extending from (and/or coupled to) the high pressure spool 122, such that the high pressure gear 172 and the high pressure gear teeth 172 form a fixed gear relationship. The high pressure gear teeth 173 extends about high pressure spool 122 in the circumferential direction C. The high pressure gear 172 and the high pressure gear teeth 173 are in gear (or in a fixed gear relationship), such that rotation of the spool 122 causes rotation of the high pressure gear 172. The high pressure gear 172 is disposed entirely within the sump 180, and the high pressure shaft 174 is disposed at least partially within the sump 180.

The low pressure geartrain 170 may include a low pressure gear 176 and a low pressure shaft 178 coupled to the low pressure gear 176. The low pressure gear 176 is coupled in gear with the low pressure spool 124 within the sump 180, and the low pressure shaft 178 may extend from the low pressure gear 176 out of the sump 180. That is, the low pressure shaft 178 may rotate with and couple to the low pressure gear 176. For example, the low pressure gear 176 is meshed or engaged with low pressure gear teeth 177 extending from (and/or coupled to) the low pressure spool 124, such that the low pressure gear 176 and the low pressure gear teeth 177 form a fixed gear relationship. The low pressure gear teeth 177 may extend about low pressure spool 124 in the circumferential direction C. The low pressure gear 176 and the low pressure gear teeth 177 are in gear (or in a fixed gear relationship), such that rotation of the low pressure spool 124 causes rotation of the low pressure gear 176. The low pressure gear 176 is disposed entirely within the sump 180, and the low pressure shaft 178 is disposed at least partially within the sump 180. In many embodiments, the high pressure gear 172 and the low pressure gear 176 may each be bevel gears; however, other gear types are possible.

As shown in FIG. 2, the high pressure geartrain 168 and the low pressure geartrain 170 may each extend through a strut 166 of the plurality of struts 166 (e.g., either the same strut or different struts). Particularly, the low pressure shaft 178 may extend from the low pressure gear 176 within the sump 180, out of the sump 180 and through the strut 166, and into the outer casing 106. Similarly, the high pressure shaft 174 may extend from the high pressure gear 172, out of the sump 180 and through the strut 166, and into the outer casing 106.

In exemplary embodiments, as shown in FIG. 2 the low pressure geartrain 170 is coupled in gear with the low pressure spool 124 and the high pressure geartrain 168 is coupled in gear with the high pressure spool 122 at a common axial location relative to the centerline axis 101 of the gas turbine engine 100. That is, the high pressure gear 172 and the low pressure gear 176 are disposed at a common axial location. In other words, an imaginary radial line drawn at the axial location of the high pressure gear 172 and the low pressure gear 176 would intersect both the high pressure gear 172 and the low pressure gear 176. The high pressure gear 172 and the low pressure gear 176 may at least partially axially overlap (such as entirely or 100% axial overlap, or such as about an 80% axial overlap, or such as about a 60% axial overlap, or such as about a 50% axial overlap, or such as about a 20% axial overlap, or such as about a 5% axial overlap).

In many embodiments, the common axial location is axially between the low pressure compressor 110 and the high pressure compressor 112. That is, the high pressure gear 172 and the low pressure gear 176 may each be coupled to a respective spool 122, 124 between the low pressure compressor 110 and the high pressure compressor 112. The high pressure gear 172 and the low pressure gear 176 may each be disposed axially between the low pressure compressor 110 and the high pressure compressor 112 outside of the air flowpath 156 (e.g., within the sump 180).

The high pressure shaft 174 of the high pressure geartrain 168 and the low pressure shaft 178 of the low pressure geartrain 170 may each be coupled to an output device 190 disposed a stationary frame of the gas turbine engine (such as the outer casing 106). The output device 190 shown in FIG. 2 corresponds with the output device 142 shown in FIG. 1. The output device 190 may be at least one of an accessory gearbox 192 and/or a power transfer device 194. In some embodiments, the power transfer device 194 may be disposed within the accessory gearbox 192. In other embodiments, the power transfer device 194 may be disposed outside of the accessory gearbox 192 and within the outer casing 106. The accessory gearbox 192 may coupled to one or more accessories, which may be powered and/or driven by the HP spool 122 and/or the LP spool 124 via the geartrains 168, 170, thereby drawing power from the spools 122, 124. The power transfer device 194 may transfer power directly from one of the HP spool 122 and the LP spool 124 to the other of the HP spool 122 and the LP spool 124 via the geartrains 168, 170.

Referring now to FIG. 3, a cross-sectional view (e.g., aft looking forward) of the compressor section of the gas turbine engine 100 from FIG. 2 is illustrated in accordance with embodiments of the present disclosure. As described above, the outer casing 106 and the inner duct 154 may define the core air flowpath 156. A plurality of struts 166 extend through the core air flowpath 156 between the outer casing 106 and the inner duct 154. The plurality of struts 166 are circumferentially spaced apart (e.g., equally or unequally) within the core air flowpath 156. The high pressure geartrain 168 is mechanically coupled to, and rotates with, the high pressure spool 122 (e.g., in a fixed gear relationship), and the low pressure geartrain 170 is mechanically coupled to, and rotates with, the low pressure spool 124 (e.g., in a fixed gear relationship).

As shown, the high pressure geartrain 168 and the low pressure geartrain 170 are circumferentially spaced apart from one another. Stated otherwise, the high pressure geartrain 168 is circumferentially spaced apart from the low pressure geartrain 170. In exemplary embodiments, as shown in FIG. 3, the high pressure geartrain 168 may extend through a first strut 166 of the plurality of struts 166, and the low pressure geartrain 170 may extend through a second strut 166 of the plurality of struts 166. In the depicted embodiment, the first and second struts 166 are different. Particularly, the first strut 166 may directly circumferentially neighbor the second strut 166 within the core air flowpath 156. However, in other embodiments, as shown in FIG. 2, the high pressure geartrain 168 and the low pressure geartrain 170 may extend through a common strut 166 of the plurality of struts 166.

As shown in FIG. 3, the geartrains 168, 170 may extend into the accessory gearbox 192 within the outer casing 106. Particularly, the accessory gearbox 192 may include a gearbox housing 196 that encases (or houses) one or more accessory drive gears 208. The high pressure geartrain 168 includes a high pressure output gear 200 coupled to the high pressure shaft 174 and disposed within the gearbox housing 196. Similarly, the low pressure geartrain 170 includes a low pressure output gear 202 coupled to the low pressure shaft 178 and disposed within the gearbox housing 196. The output gears 200, 202 may each be coupled to, and rotate with, the power transfer device 194 (e.g., via a first shaft 210 and a second shaft 212). The power transfer device 194 may be adjusted or actuated to selectively transfer power between the spools 122, 124 via the geartrains 168, 170. Additionally, or alternatively, one of the output gears 200, 202 may be coupled (either directly or via an additional shaft, as indicated by the phantom line 201 in FIG. 3) to an accessory drive gear 208 within the accessory gearbox 192, such that the accessory drive gear 208 is powered by one of the spools 122, 124 via one of the geartrains 168, 170. The accessory drive gear 208 may power an accessory, such an environmental control system (ECS) compressor, a fuel pump, a lubrication pump, a starter motor, and/or a generator.

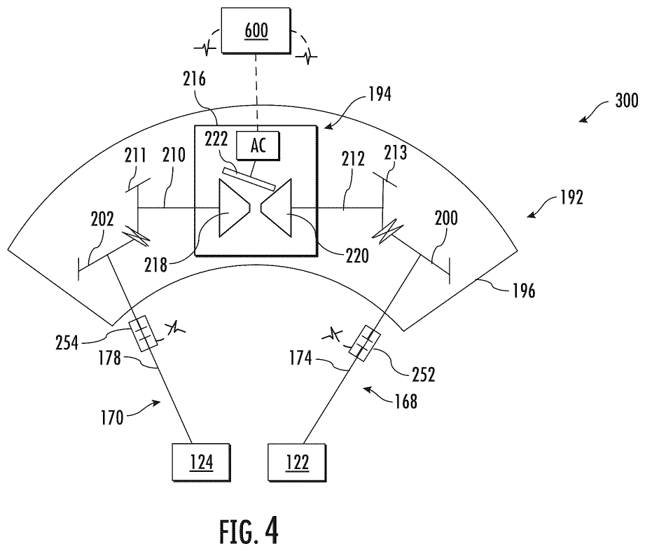

FIGS. 4 and 6-12 each illustrate a schematic view of a mechanical power sharing arrangement 300, which may be incorporated into the gas turbine engine 100 as shown in FIGS. 1 and 2, in accordance with embodiments of the present disclosure. As shown, the mechanical power sharing arrangement 300 includes the high pressure geartrain 168 coupled to the high pressure spool 122 and the low pressure geartrain 170 coupled to the low pressure spool 124. In some embodiments, the high pressure geartrain 168 includes the high pressure shaft 174 and the high pressure output gear 200, and the low pressure geartrain 170 includes the low pressure shaft 178 and the low pressure output gear 202. In some embodiments, the output gears 200, 202 are disposed in the gearbox housing 196 of the accessory gearbox 192. The output gears 200, 202 may be bevel gears in exemplary embodiments; however, other gear types may be possible.

Referring specifically to FIG. 4, as shown, the mechanical power sharing arrangement 300 includes a power transferring device 194 coupling the high pressure geartrain 168 and the low pressure geartrain 170 to transfer power between the high pressure spool 122 and the low pressure spool 124. Particularly, in the embodiment shown, the power transfer device 194 can be a continuous variable transmission (CVT) 216 which may be actuated (e.g., via a controller 600) to adjust the power sharing between the spools 122, 124. The CVT 216 includes a first shaft 210 coupled to the low pressure geartrain 170 and a second shaft coupled to the high pressure geartrain 168. Particularly, a first gear 211 is disposed on, and coupled to, an end of the first shaft 210. The first gear 211 is meshed with (or engaged with) the output gear 202 of the low pressure geartrain 170, such that rotation of the output gear 202 causes rotation of the first gear 211. Similarly, a second gear 213 is disposed on, and coupled to, an end of the second shaft 212. The second gear 213 is coupled to the output gear 200 of the high pressure geartrain 168. As used herein, when one gear is “coupled to” or “rotatably coupled to” another gear, this may be in a meshed gear relationship, such that rotation of one gear causes rotation of the other gear.

The CVT 216 includes an input disc 218 coupled to the first shaft 210, an output disc 220 coupled to the second shaft 212, and one or more roller assemblies 222 disposed between the input disc 218 and the output disc 220. The roller assemblies 222 may be actuated, e.g., via one or more actuators AC, by the controller 600. That is, the controller 600 may be in operable communication with the one or more actuators AC to adjust a position of the roller assemblies 222. For example, the roller assemblies 222 may be actuated between a first position, a second position, and a neutral. The first position may provide power from the HP spool 122 to the LP spool 124, the second position may provide power from the LP spool to the HP spool, and the neutral position may not transfer any power between the spools 122, 124.

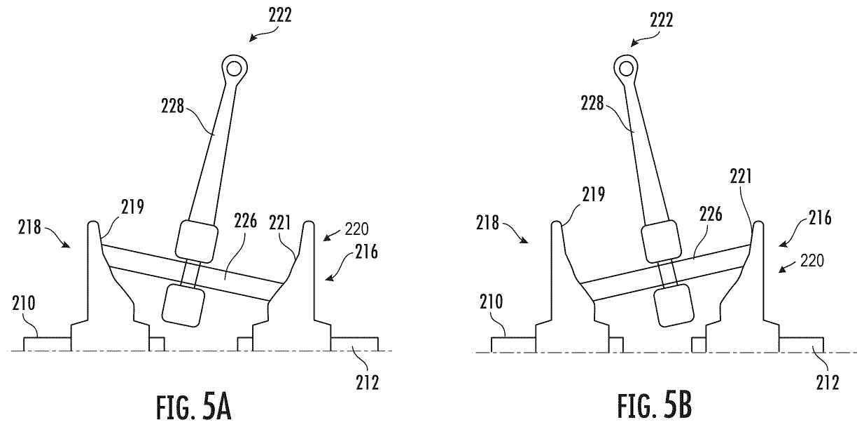

Referring now to FIGS. 5A and 5B, two side views of the CVT 216 are illustrated in accordance with exemplary aspects of the present disclosure. Particularly, FIG. 5A illustrates the CVT 216 in a first position, and FIG. 5B illustrates the CVT 216 in a second position. As shown, the CVT 216 includes the input disc 218 coupled to the first shaft 210, the output disc 220 coupled to the second shaft 212, and one or more roller assemblies 222 disposed between the input disc 218 and the output disc 220. The discs 218, 220 may each include a curved surface 219, 221, which contact the roller assemblies 222.

The input disc 218 includes a loading cam (not shown), which may advantageously adjust the contact pressure between the roller assemblies 222 and the discs 218, 220 to ensure the roller assemblies 222 maintain the necessary grip to transfer power effectively without slipping. The roller assemblies 222 may each include power rollers 226 and trunnions 228. The power rollers 226 may engage the curved surfaces 219, 221. The trunnions 228 may adjust the angle of the power rollers 226, thereby adjusting the power exchange between the input and output discs 218, 220. That is, the trunnions 228 may change the angle of tilt of the roller assemblies 222 (as shown by comparing FIGS. 5A and 5B), which varies the effective diameter at which the discs 218, 220 engage, thereby allowing for a continuous range of gear ratios.

While the CVT 216 is shown and described as a toroidal CVT in exemplary embodiments, it should be appreciated that the CVT 216 may be any type of CVT in other embodiments (such as a belt CVT, a chain CVT, a toroidal CVT, or others), and the present disclosure should not be limited to any particular type of CVT unless specifically provided in the claims.

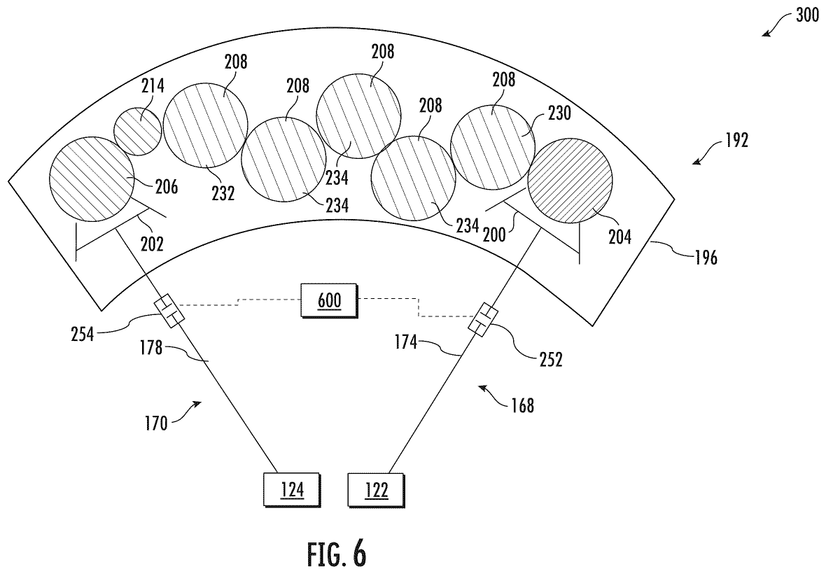

Referring now to FIGS. 6 through 11, in some embodiments, the mechanical power sharing arrangement includes a plurality of accessory drive gears 208 disposed within the gearbox housing 196. The plurality of accessory drive gears 208 are coupled (either directly or indirectly) with one of the high pressure geartrain 168 and/or the low pressure geartrain 170 for powering one or more accessories. For example, each of the accessory drive gears 208 may power an accessory of the gas turbine engine 100 (shown in FIGS. 1-3), such as an environmental control system (ECS) compressor, a fuel pump, a lubrication pump, a starter motor, a generator, and/or other accessories.

As shown in FIGS. 6 through 11, the geartrains 168, 170 may further include transition gears 204, 206. In such embodiments, the output gears 200, 202 are coupled to, and rotate with, one or more transition gears 204, 206, which may adjust the direction of rotation of the output gears 200, 202 for connection with other components. For example, a high pressure transition gear 204 may couple to, and rotate with, the high pressure output gear 200. Similarly, a low pressure transition gear 206 may couple to, and rotate with, the low pressure output gear 202.

Additionally, in some embodiments, the spools 122, 124 may be counter rotating, such that they rotate in opposite directions relative to one another. In such embodiments, as shown in FIGS. 6 through 11, the mechanical power sharing arrangement 300 may further include a reversing gear 214 disposed between an accessory drive gear 208 and one of the low pressure geartrain 170 or the high pressure geartrain 168. Particularly, the reversing gear 214 may be disposed between the low pressure transition gear 206 and an accessory drive gear 208 of the plurality of accessory drive gears 208. The reversing gear 214 may ensure that power is sufficiently shared between the spools 122, 124 in a counter rotating system.

Alternatively, for a system that includes co-rotating spools 122, 124, such that the spools 122, 124 rotate in the same direction, the reversing gear may not be included, and the geartrains 168, 170 may be directly coupled to the accessory drive gear 208 without a reversing gear.

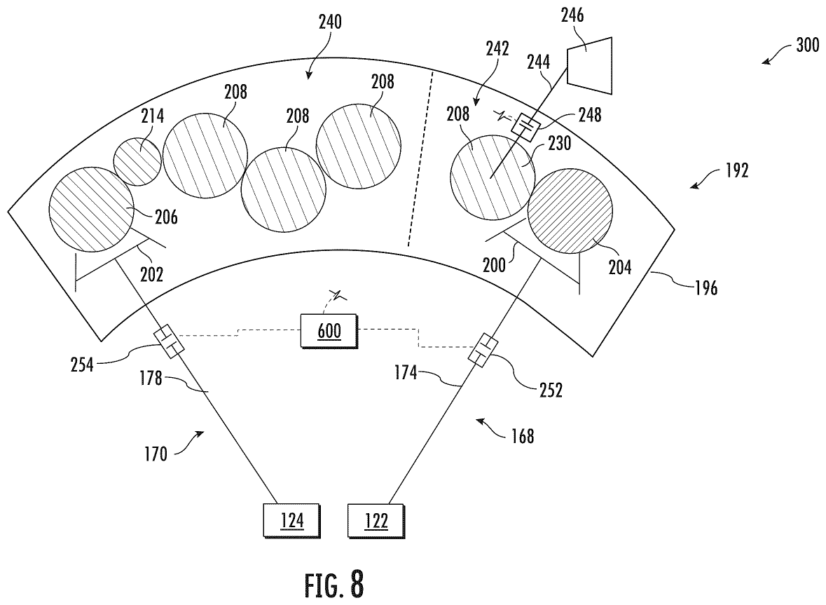

Referring to FIGS. 4 and 6-11, in exemplary embodiments, power transfer device 194 and/or the accessory drive gears 208 may be selectively drivingly coupled to at least one of the high pressure geartrain 168 and/or the low pressure geartrain 170. For example, in some embodiments (as shown in FIG. 6), the accessory drive gears 208 may selectively drivingly coupled to both of the high pressure geartrain 168 and the low pressure geartrain 170. In other embodiments (as shown in FIG. 8), the accessory drive gears 208 may selectively drivingly coupled to only one of the high pressure geartrain 168 or the low pressure geartrain 170.

As shown in FIGS. 4 and 6-11, the power transfer device 194 and/or the accessory drive gears 208 may be selectively drivingly coupled via a high pressure clutch 252 and a low pressure clutch 254. That is, the high pressure geartrain 168 includes the high pressure clutch 252 for selectively decoupling the high pressure geartrain 168 from the power transfer device 194 and/or the accessory gearbox 192 (e.g., the accessory drive gears 208 within the accessory gearbox 192). Similarly, the low pressure geartrain 170 includes the low pressure clutch 254 for selectively decoupling the low pressure geartrain 170 from the accessory gearbox 192 (e.g., the accessory drive gears 208 within the accessory gearbox 192). The high pressure clutch 252 and the low pressure clutch 254 may each be in operative communication with the controller 600 (as indicated by the phantom lines).

The high pressure clutch 252 and the low pressure clutch 254 may each be independently movable or actuatable (e.g., by the controller 600) between an engaged position and a disengaged position. In the engaged position, power may be permitted to transfer from the respective spool 122, 124, through the respective geartrain 168, 170, to one of the power transfer device 194 or the accessory drive gears 208. In the disengaged position power may be prevented from transferring from the respective spool 122, 124, through the respective geartrain 168, 170, to the power transfer device 194 or the accessory drive gears 208. In other words, in the disengaged position, the geartrains 168, 170 may be effectively decoupled from the spools 122, 124 and the power transfer device 194 or the accessory drive gears 208.

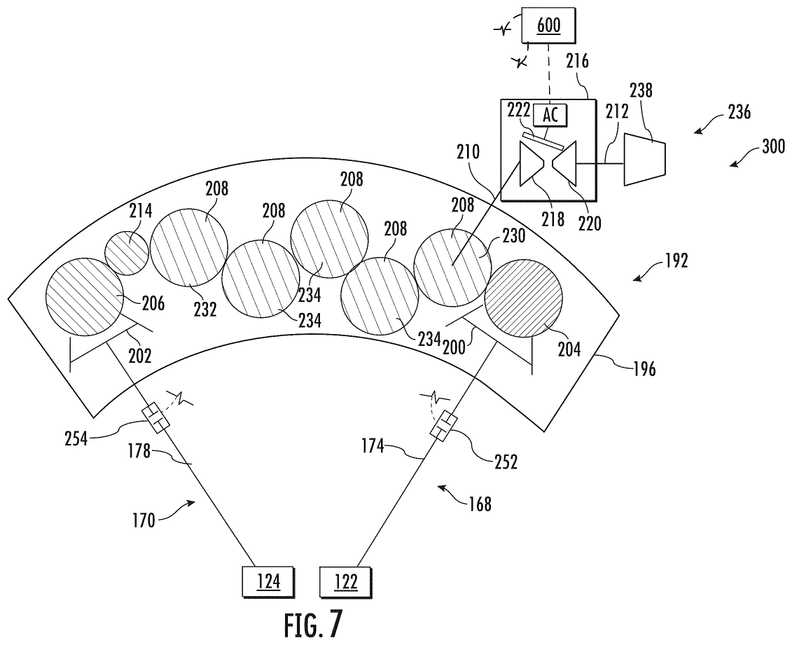

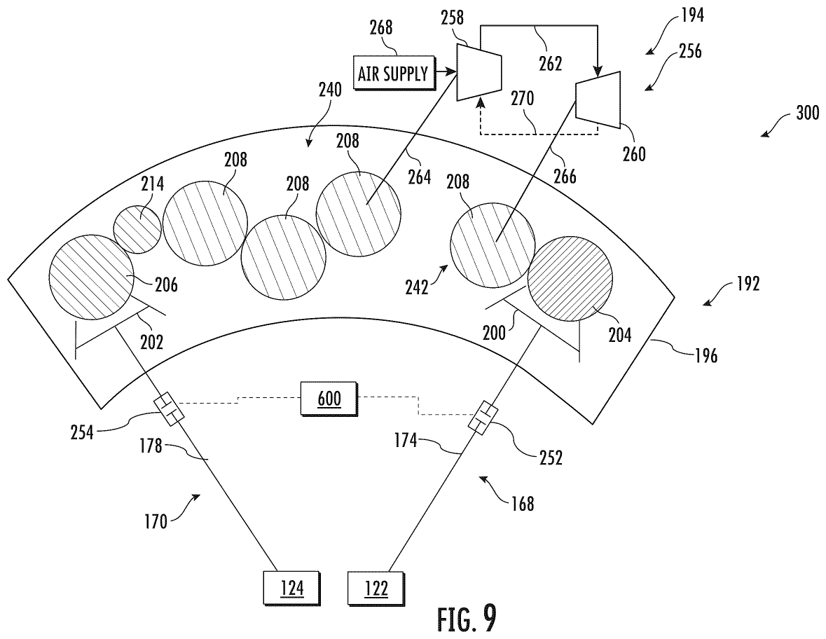

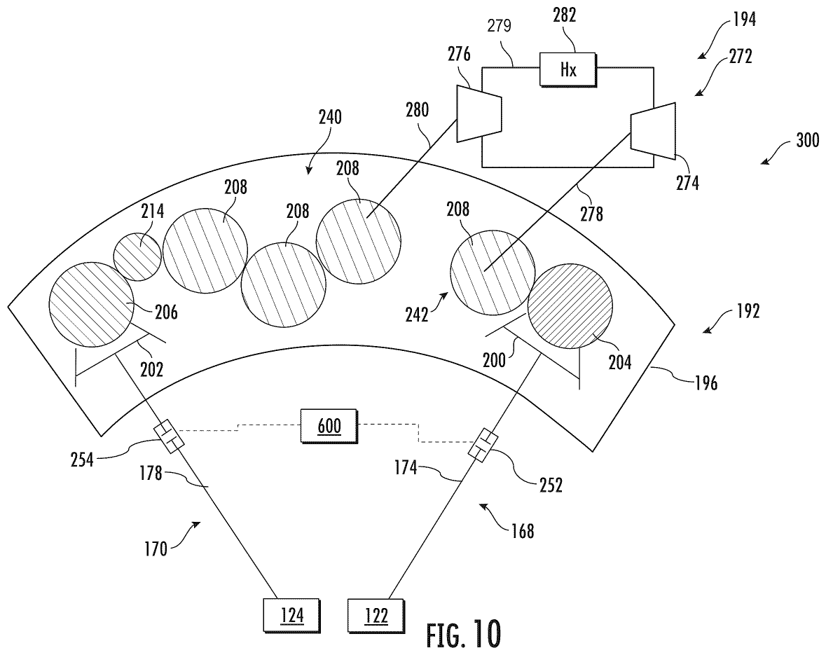

Referring specifically to the embodiments shown in FIGS. 6, 7, 9, and 10, as shown, power may be transferred between the spools 122, 124 across a plurality of accessory drive gears 208 (FIGS. 6 and 7) and/or across a plurality of accessory drive gears 208 and a power transfer device 194 (FIGS. 9 and 10). In such embodiments, the accessory drive gears 208 may be selectively driven by the high pressure geartrain 168 in a first operating condition and the low pressure geartrain 170 in a second operating condition. For example, in the first operating condition, the high pressure clutch 252 is in an engaged position and the low pressure clutch 254 is in a disengaged position such that the accessory drive gears 208 are powered (e.g., exclusively) by the high pressure geartrain 168. In the second operating condition, the high pressure clutch 252 is in the disengaged position and the low pressure clutch 254 is in the engaged position such that the accessory drive gears 208 are powered (e.g., exclusively) by the low pressure geartrain 170.

The first operating condition, in which the HP spool 122 provides power to the accessory drive gears 208, may be take-off conditions (in which an aircraft is taking off the ground), climb conditions (in which the aircraft is ascending), and cruise conditions (in which the aircraft is in a steady state and altitude). The second operating condition, in which the LP spool 124 provides power to the accessory drive gears 208, may be descent conditions, ground conditions (in which the aircraft is on the ground), and/or taxi conditions (in which the aircraft is being pulled by a taxi vehicle on the ground).

Referring now specifically to FIG. 6, as shown, the plurality of accessory drive gears 208 may be coupled to both the high pressure geartrain 168 and the low pressure geartrain 170, such that power may be transferred from the spools 122, 124 to the accessory drive gears 208 and/or from one spool 122, 124 to another spool 122, 124 across the accessory drive gears 208. In such embodiments, the plurality of accessory drive gears 208 includes a first accessory drive gear 230 coupled to the high pressure geartrain 168 and a second accessory drive gear 232 coupled to the low pressure geartrain 170. Additionally, the plurality of accessory drive gears 208 includes one or more intermediate accessory drive gears 234 disposed between the first accessory drive gear 230 and the second accessory drive gear 232. The first accessory drive gear 230 may be coupled to, and rotate with, the high pressure transition gear 204 and an intermediate accessory drive gear 234. The second accessory drive gear 232 may be coupled to, and rotate with, the reversing gear 214 and an intermediate accessory drive gear 234. The one or more intermediate drive gears 234 may each be coupled to, and rotate with, one or more of the first accessory drive gear 230, the second accessory drive gear 232, and/or an adjacent intermediate accessory drive gear 234.

Referring now to FIG. 7, in some embodiments, the CVT 216 may be coupled to one of the accessory drive gears 208. For example, as shown in FIG. 7, the first shaft 210 of the CVT 216 may be coupled to an accessory drive gear 208, and the second shaft 212 of the CVT may be coupled to an accessory 236. In various embodiments, the accessory 236 may be one of an environmental control system (ECS) compressor, a fuel pump, a lubrication pump, and a generator. However, in exemplary embodiments, as shown, the accessory 236 may be an ECS compressor 238. The ECS compressor 238 may compress air for the environmental control system, which maintains the temperature of the aircraft cabin. Alternatively, or additionally, the compressed air may from the ECS compressor 238 may be used for anti-icing the wings of the aircraft (e.g., preventing ice build up on the wings). The air for the ECS compressor 238 may be provided from the bypass airflow passage 140, may be bled from the low pressure compressor 110, and/or may be bled from the high pressure compressor 112. Coupling the ECS compressor 238 to the CVT transmission 216 advantageously allows for a full range of operability of the ECS compressor 238 and allows for the ECS compressor 238 to be powered by the spools 122, 124 via the geartrains 168, 170. As described above, the CVT 216 includes an input disc 218 coupled to the first shaft 210, an output disc 220 coupled to the second shaft 212, and one or more roller assemblies 222 disposed between the input disc 218 and the output disc 220. The roller assemblies 222 may be actuated, e.g., via one or more actuators AC, by the controller 600. Actuating the roller assemblies 222 may allow for full control of the rotation speed of the ECS compressor 238.

Referring now to FIGS. 8-10, as shown, the accessory gearbox 219 includes a first group 240 of accessory drive gears 208 driven by the low pressure geartrain 170 and a second group 242 of accessory drive gears 208 driven by the high pressure geartrain 168. In this way, power may be selectively pulled from the low pressure spool 124 via the low pressure geartrain 170 to drive the first group 240 of accessory drive gears 208. Similarly, power may be selectively pulled from the high pressure spool 122 via the high pressure geartrain 168 to drive the second group 242 of drive gears 208. The first group 240 includes three accessory drive gears 208, and the second group includes a single accessory drive gear 208. However, groups 240, 242 includes any number of accessory drive gears 208 and should not be limited to any particular number unless specifically recited in the claims.

As shown in FIG. 8, the first group 240 and the second group 242 may be spaced apart and not coupled to one another. In this way, the high pressure geartrain 168 and the low pressure geartrain 170 may be mechanically isolated from one another, such that power may not be directly transferred between the spools 122, 124. Instead, power may be selectively pulled from the spools 122, 124 by operating the groups 240, 242 of accessory drive gears 208 (i.e., by operating the accessories powered by the accessory drive gears 208). For example, to remove power from the LP spool 124, the first group 240 of accessory drive gears 208 may be driven by the low pressure geartrain 170. Similarly, to pull power (i.e., remove power) from the HP spool 122, the second group 242 of accessory drive gears 208 may be driven by the high pressure geartrain 168.

Additionally, as shown in FIG. 8, in embodiments having two separately driven groups 240, 242 of accessory drive gears 208, the accessory gear box 192 may be divided into multiple segments or may be separated entirely into two distinct accessory gear boxes 192 (as shown by the phantom line representing a wall that may be added in some embodiments). Alternatively, both the first group 240 and the second group 242 may be housed in a common accessory gear box 192.

As shown in FIG. 8, at least one accessory drive gear 208 in the second group 242 may be coupled to (and rotate with) an input shaft 244 of an air turbine starter (ATS) 246. In this way, the ATS 246 may be driven (or powered) by the HP spool 122 via the high pressure geartrain 168. As should be appreciated, the ATS 246 may be used for starting a gas turbine engine (such as the gas turbine engine 100 described above with reference to FIGS. 1-3). That is, the internal components of both the gas turbine engine and the air turbine starter spin together such that the air turbine starter can be used to start the turbine engine.

In many embodiments, as shown in FIG. 8, the ATS 246 may further include an ATS clutch 248 for selectively decoupling the ATS 246 from the high pressure geartrain 168. The ATS clutch 248 may be in operative communication with the controller 600, which may operate the ATS clutch 248 to selectively decouple the ATS 246 from the high pressure geartrain 168. As shown, in some embodiments, the ATS clutch 248 may be disposed on the input shaft 244. However, in other embodiments, the ATS clutch 248 may be positioned differently. The ATS clutch 248 may be selectively moveable (e.g., by the controller 600) between an engaged position and a disengaged position. In the engaged position, power from the HP spool 122 may be provided to the ATS 246, such that the ATS 246 rotates with the HP spool 122 via the high pressure geartrain 168. In the disengaged position, the power transmission between the HP spool 122 and the ATS 246 may be entirely prevented or disengaged, such that the ATS 246 does not receive power from the HP spool 122.

In the embodiment depicted in FIG. 8, the high pressure geartrain 168 only powers the ATS 246. That is, no other accessories are driven by the high pressure geartrain 168. This may advantageously ensure that the ATS 246 receives adequate power from the high pressure spool 122 by not dividing the power between multiple accessories. However, in some embodiments (not shown), the high pressure geartrain 168 may power the ATS 246 in addition to other accessories (such as a fuel pump and/or an oil pump).

Referring specifically to FIG. 9, a power transfer device 194 may connect the first group 240 and the second group 242 of accessory drive gears 208, such that power may be transferred between the spools 122, 124 across the accessory drive gears 208 and the power transfer device 194. Specifically, as shown, the power transfer device may be a pneumatic system 256 having a pneumatic compressor 258 connected to a pneumatic turbine 260. The pneumatic compressor 258 may be coupled in gear with one of the high pressure geartrain 168 or the low pressure geartrain 170 and a pneumatic turbine 260 may be coupled in gear with the other of the high pressure geartrain 168 or the low pressure geartrain 170. For example, in the embodiment shown, the pneumatic compressor 258 may be coupled in gear with (e.g., indirectly via the accessory drive gear 208) the low pressure drivetrain 170, such that the pneumatic compressor 258 may be selectively driven by the LP spool 124. The pneumatic turbine 260 may be coupled in gear with (e.g., indirectly via the accessory drive gear 208) the high pressure drivetrain 168, such that the pneumatic turbine 260 may provide power from the pneumatic compressor 258 to the high pressure spool 122.

As shown, the pneumatic compressor 258 includes an input shaft 264 coupled to, and rotatable with, one of the accessory drive gears 208 in the first group of 240 of accessory drive gears 208. The pneumatic turbine 260 includes an output shaft 266 coupled to, and rotatable with, an accessory drive gear 208 in the second group 242 of accessory drive gears 208.

Power from the LP spool 124 may be selectively transferred to the HP spool 122 across the pneumatic system 256. For example, the pneumatic compressor 258 may be driven by the LP spool 124 via the low pressure geartrain 170 and the accessory drive gears 208. The pneumatic compressor 258 may compress air (or a working fluid), which may be provided to the pneumatic turbine 260 (e.g., via one or more connection lines 262). The compressed air (or compressed working fluid) may expand through the pneumatic turbine 260 to generate rotational energy, which may then be provided to the HP spool 122 via the high pressure geartrain 168.

The pneumatic compressor 258 may be fluidly connected to an air supply 268. Referring back to FIG. 1, briefly, the air supply 268 may provide air from the bypass airflow passage 140, air bled from the low pressure compressor 110, and/or air bled from the high pressure compressor 112. As shown in FIG. 9, air from the air supply may be pressurized by the pneumatic compressor and provided to the pneumatic turbine, such that power from the LP spool 124 may be transferred to the HP spool 122 at least partially across the pneumatic system 256.

In some embodiments, as shown by the phantom line connecting the pneumatic compressor 258 and the pneumatic turbine 260, the pneumatic system 256 includes a recirculation line 270 extending between, and fluidly coupling, the pneumatic turbine 260 and the pneumatic compressor 258. The recirculation line 270 may provide all or a portion of air (or working fluid) from an outlet of the pneumatic turbine 260 to an inlet of the pneumatic compressor 258. The recirculation line 270 and/or the connection line 262 may be pipes, tubes, ducts, and/or other fluid carrying conduits, channels, or the like.

Referring now specifically to FIG. 10, the power transfer device 194 may be a hydraulic system 272 having a first hydraulic element 274 coupled to the high pressure geartrain 168 and a second hydraulic element 276 coupled to the low pressure geartrain 170. The first hydraulic element 274 and the second hydraulic element 276 may be disposed in fluid communication on a hydraulic loop 279. The hydraulic loop 279 includes a supply line and a return line. The hydraulic loop 279 may be a series of pipes, tubes, and/or other fluid carrying conduits that contain a hydraulic fluid for use in the hydraulic elements 274, 276.

The hydraulic system 272 includes a first shaft 278 coupled to, and rotatable with, the first hydraulic element 274 and one of the accessory drive gears 208 in the second group 242 of accessory drive gears 208. The hydraulic system 272 may further include a second shaft 280 coupled to, and rotatable with, the second hydraulic element 276 and one of the accessory drive gears 208 in the first group 240 of accessory drive gears 208. Additionally, in many embodiments, a heat exchanger 282 may disposed in thermal communication on the hydraulic loop 279 (e.g., between the first hydraulic element 274 and the second hydraulic element 276). The heat exchanger 282 may advantageously cool the recirculating hydraulic fluid within the hydraulic loop 279.

Power may be transferred in either direction between the spools 122, 124 via the hydraulic system 272. For example, the first hydraulic element 274 and the second hydraulic element 276 may be interchangeably operable as both a hydraulic compressor and/or a hydraulic turbine depending on the direction power is to be transferred (e.g., between the spools 122, 124). For example, if power is to be transferred from the LP spool 124 to the HP spool 122, then the low pressure geartrain 170 may provide power to the second hydraulic element 276, which may compress the hydraulic fluid within the hydraulic loop 279 (thereby acting as a hydraulic compressor). The hydraulic fluid may then expand through the first hydraulic element 274 (thereby acting as a hydraulic turbine), and the power produced by the first hydraulic element 274 may be provided to the HP spool 122 via the high pressure geartrain 168. By contrast, if power is to be transferred from the HP spool 122 to the HP spool 124, then the high pressure geartrain 168 may provide power to the first hydraulic element 274, which may compress the hydraulic fluid within the hydraulic loop 279 (thereby acting as a hydraulic compressor). The hydraulic fluid may then expand through the second hydraulic element 276 (thereby acting as a hydraulic turbine), and the power produced by the second hydraulic element 276 may be provided to the LP spool 124 via the low pressure geartrain 170. The first hydraulic element 274 and the second hydraulic element 276 may be referred to as “a first combination turbine and compressor” and “a second combination turbine and compressor.”

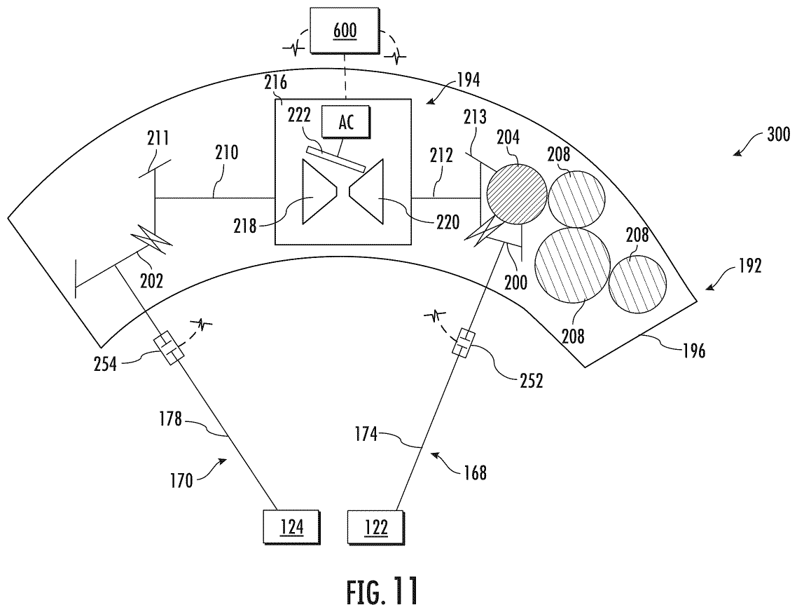

Referring now to FIG. 11, in some embodiments, the mechanical power sharing arrangement 300 includes the CVT 216 disposed within the gearbox housing 196. For example, the CVT 216 includes a first shaft 210 coupled to the low pressure geartrain 170 and a second shaft coupled to the high pressure geartrain 168 within the gearbox housing 196. Particularly, the first shaft 210 may be coupled to the low pressure output gear 202 and the second shaft coupled to the high pressure output gear 200 (e.g. either directly or indirectly through the transition gear 204). More particularly, a first gear 211 may be disposed on, and coupled to, an end of the first shaft 210. The first gear 211 may be coupled to the output gear 202 of the low pressure geartrain 170. Similarly, a second gear 213 may be disposed on, and coupled to, an end of the second shaft 212. The second gear 213 may be coupled to the output gear 200 and/or the transition gear 204 of the high pressure geartrain 168. Additionally, the high pressure output gear 200 may be further coupled to one or more accessory drive gears 208 (e.g., indirectly through the transition gear 204).

The CVT 216 includes an input disc 218 coupled to the first shaft 210, an output disc 220 coupled to the second shaft 212, and one or more roller assemblies 222 disposed between the input disc 218 and the output disc 220. The roller assemblies 222 may be actuated, e.g., via one or more actuators AC, by the controller 600. That is, the controller 600 may be in operable communication with the one or more actuators AC to adjust a position of the roller assemblies 222. For example, the roller assemblies 222 may be actuated between a first position, a second position, and a neutral. The first position may provide power from the HP spool 122 to the LP spool 124, the second position may provide power from the LP spool to the HP spool, and the neutral position may not transfer any power between the spools 122, 124.

In such an arrangement, power may be transferred between the spools 122, 124 (and across the CVT 216) while simultaneously providing power to the accessory drive gears 208. Alternatively, one of the clutches 252, 254 may be shifted to a disengaged position, and the other of the clutches 252, 254 may be in engaged position, such that power from one of the spools 122, 124 is provided only to the accessory drive gears 208 (either across the CVT 216 if the power is from the LP spool 124 or directly from the HP spool 122 via the high pressure geartrain 168).

Additionally, as shown in FIG. 11, in many embodiments, the high pressure output gear 200, the low pressure output gear 202, the accessory drive gears 208, and the CVT 216 may be disposed within the gearbox housing 196. That is, the gearbox housing 196 may surround or encase each of the high pressure output gear 200, the low pressure output gear 202, the accessory drive gears 208, and the CVT 216.

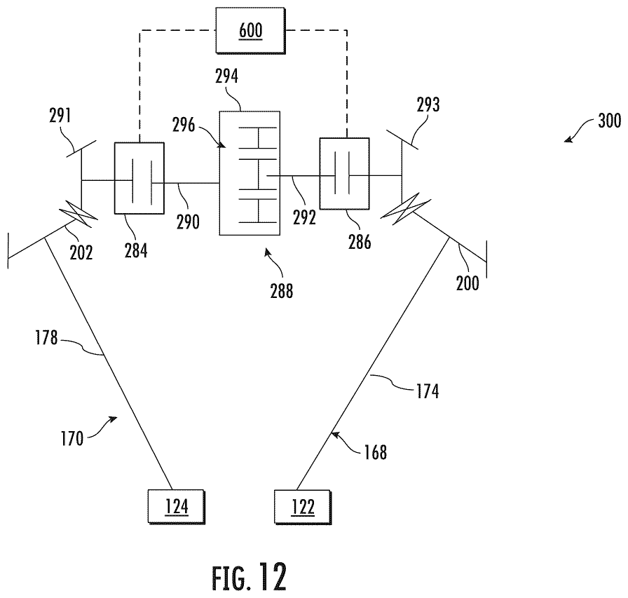

Referring now to FIG. 12, in some embodiments, the power transferring device 194 includes a gearbox transmission 288. In such embodiments, the HP spool 122 and the LP spool 124 may be clutched together via one or more clutches 284, 286 and the gearbox transmission 288. The gearbox transmission 288 includes a first shaft 290 connected to, and rotatable with, the low pressure geartrain 170. Particularly, the first shaft 290 includes a first gear 291 at an end of the first shaft 290, and the first gear 291 may be connected to (e.g., meshed with and/or in gear with) the low pressure output gear 202. The gearbox transmission 288 may further include a second shaft 292 connected to, and rotatable with, the high pressure geartrain 168. Particularly, the second shaft 292 includes a second gear 293 at an end of the second shaft 292, and the second gear 293 may be connected to (e.g., meshed with or in gear with) the high pressure output gear 200.

The gearbox transmission 288 includes a housing 294 and a plurality of gears 296. The plurality of gears may be coupled to each of the first and second shafts 290, 292. The gearbox transmission 288 may adjust the speed ratio between the first and second shafts 290, 292 (e.g., via the plurality of gears 296) to ensure the geartrains provide 168, 170 transfer power between the spools 122, 124 at an adequate speed.

The first clutch 284 may be coupled to the first shaft 290, and the second clutch 286 may be coupled to the second shaft 292. The first clutch 284 may selectively decouple the low pressure geartrain 170 from the gearbox transmission 288, and the second clutch 286 may selectively decouple the high pressure geartrain 168 from the gearbox transmission 288.

The first clutch 284 and the second clutch 286 may be in operable communication with the controller 600 The first clutch 284 and the second clutch 286 may each be movable or actuatable (e.g., by the controller 600) between an engaged position and a disengaged position. When both clutches 284, 286 are in the engaged position, power may be permitted to transfer from between the spools 122, 124 (e.g., through the geartrains 168, 170 and the gearbox transmission 288). When both clutches 284, 286 are in the disengaged position, power may be prevented from between the spools 122, 124. In the arrangement shown in FIG. 12, it may be advantageous to actuate the clutches 284, 286 together, such that they are both in the same position. This prevents unnecessary windage in the gearbox transmission 288, which could cause losses in energy.

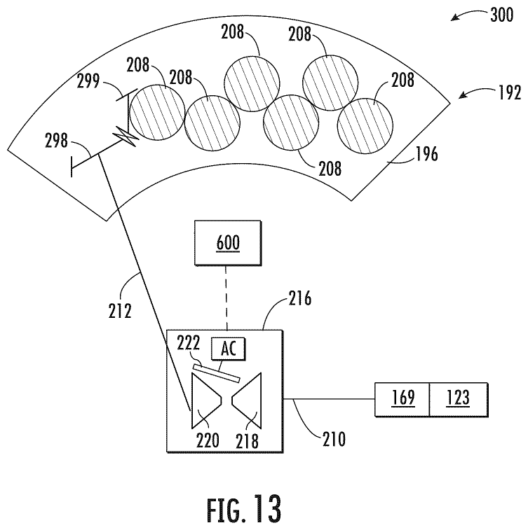

Referring now to FIG. 13, a mechanical power sharing arrangement 300 is illustrated in accordance with embodiments of the present disclosure. As shown, the first shaft 210 of the CVT 216 may be coupled to, and rotate with, a geartrain 169 (such as the high pressure geartrain 168 or the low pressure geartrain 170 described above). The geartrain 169 may be coupled to, and rotate with a spool 123 (such as the high pressure spool 122 or the low pressure spool 124 described above).

The second shaft 212 of the CVT may be coupled (e.g., directly or indirectly) to a plurality of accessory drive gears 208, in order to provide power to (or drive) the accessory drive gears 208, thereby providing power to the accessories. For example, the second shaft 212 may couple to an output gear 298, which may couple to a transition gear 299. The output gear 298 and the transition gear 299 may be bevel gears. The transition gear 299 may couple to a first accessory drive gear 208 of the plurality of accessory drive gears 208. The plurality of accessory drive gears 208 may each be coupled to one or more adjacent accessory drive gears 208. The accessory drive gears 208 may be any type of gear, such as a spur gear or other types. The configuration shown in FIG. 13 advantageously allows for the plurality of accessory drive gears 208 to be driven at the same speed regardless of the output speed of the spool 123. For example, by actuating the CVT 216 based on the input speed from the spool 123, a desired output speed may be achieved for powering the accessory drive gears 208.

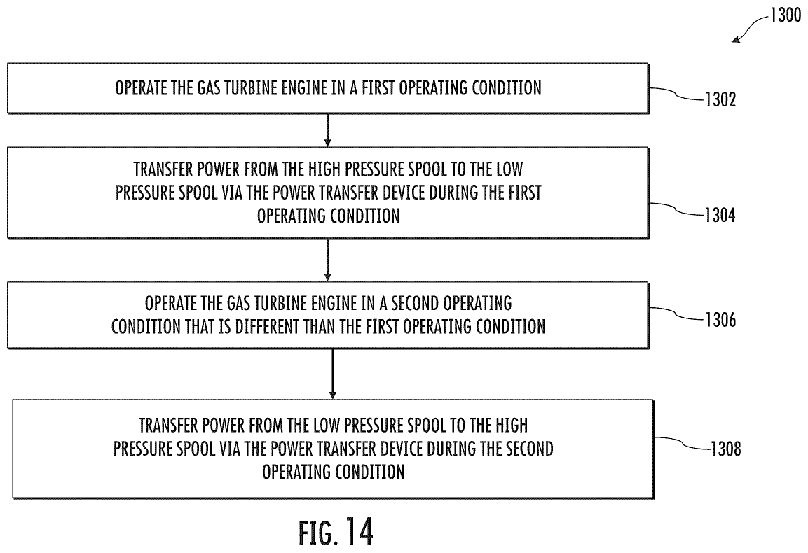

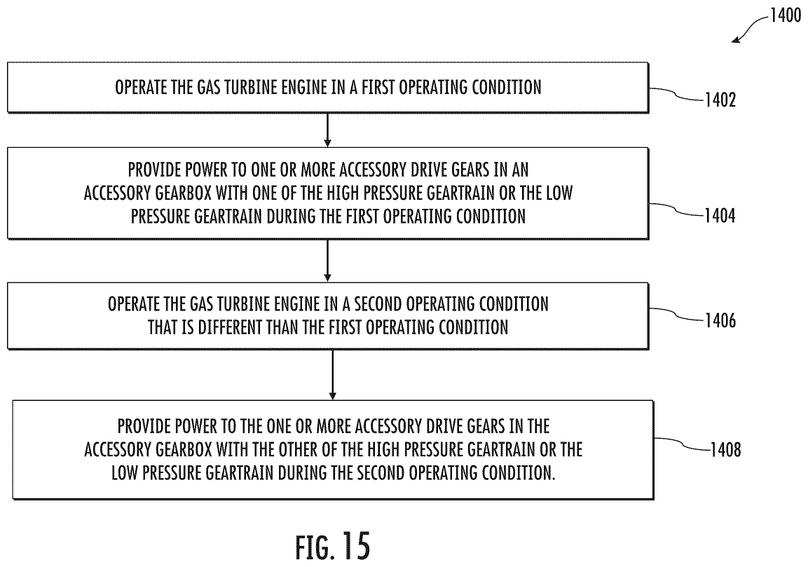

Referring now to FIGS. 14 and 15, flow diagrams of methods 1300, 1400 of operating a gas turbine engine are illustrated in accordance with embodiments of the present subject matter. In general, the methods 1300, 1400 will be described herein with reference to gas turbine engine 100 and the mechanical power sharing arrangements described above with reference to FIGS. 1-13. However, it will be appreciated by those of ordinary skill in the art that the disclosed methods 1300, 1400 may generally be utilized with any other suitable system configuration. In addition, although FIGS. 14 and 15 depict steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As shown in FIG. 14, a method 1300 of operating a gas turbine engine is provided. The gas turbine engine includes a high pressure spool coupled to a high pressure geartrain and a low pressure spool coupled to a low pressure geartrain. The high pressure geartrain and the low pressure geartrain may be coupled to a power transfer device.

The method 1300 includes at (1302) operating the gas turbine engine in a first operating condition. For example, the first operating condition may be one of a take off condition, a climb condition, and a cruise condition. In the take off condition, the gas turbine engine may be increasing speed and power to allow the aircraft to which it is attached to take off the ground. In the climb condition, the gas turbine engine may be operating at high power and speed to allow the aircraft to ascend. In the cruise conditions, the gas turbine engine may be at a steady speed to allow the aircraft to maintain altitude. The gas turbine engine may be configured similarly to the gas turbine engine 100 shown in FIGS. 1-3.

The method 1300 may further include at (1304) transferring power from the high pressure spool to the low pressure spool via the power transfer device during the first operating condition. That is, the power transfer device may pull power from the high pressure spool and add that power to the low pressure spool (e.g., to increase the speed of the low pressure spool) during the first operating conditions, which may increase the efficiency of the gas turbine engine during the first operating conditions.

In many implementations, the method 1300 may further include at (1306) operating the gas turbine engine in a second operating condition that is different than the first operating condition. For example, the second operating condition may be one of a descent condition, a ground idle condition, and/or a taxi condition. In the descent condition, the gas turbine engine may be decelerating and/or may be operating such that the aircraft to which it is attached is descending. In the ground idle condition, the gas turbine engine may be operating at a low speed (e.g., much lower than climb or cruise conditions). In the taxi condition, the aircraft is pulled by a taxi vehicle, and the gas turbine engine may be slowing to a halt.

The method 1300 may further include at (1308) transferring power from the low pressure spool to the high pressure spool via the power transfer device during the second operating condition. That is, the power transfer device may pull power from the low pressure spool and add that power to the high pressure spool (e.g., to modify the speed of the high pressure spool) during the second operating conditions, which may increase the efficiency of the gas turbine engine during the second operating conditions.

For example, in many embodiments, the power transfer device may be a continuous variable transmission (CVT). In such embodiments, the method includes transferring power between the high pressure spool and the low pressure spool via the CVT. Particularly, the CVT includes an input disc coupled to a first shaft, an output disc coupled to a second shaft, and one or more roller assemblies disposed between the input disc and the output disc. In such embodiments, the method may further include actuating the one or more roller assemblies to adjust an amount of power transferred between the high pressure spool and the low pressure spool. For example, as shown in FIGS. 4, 5A, and 5B actuating the roller assemblies 222 may adjust the relative speed between the discs 218, 220, thereby adjusting the amount of power transferred between the spools 122, 124.

In other embodiments, the power transfer device includes a hydraulic system having a first hydraulic element coupled to high pressure geartrain the and a second hydraulic element coupled to the low pressure geartrain. In such embodiments, the method may further include transferring power between the low pressure spool and the high pressure spool via the hydraulic system. For example, the first hydraulic element and the second hydraulic element may be interchangeably operable as both a hydraulic compressor and/or a hydraulic turbine depending on the direction power is to be transferred (e.g., between the spools). For example, if power is to be transferred from the LP spool to the HP spool, then the low pressure geartrain may provide power to the second hydraulic element, which may compress the hydraulic fluid within the hydraulic loop (thereby acting as a hydraulic compressor). The hydraulic fluid may then expand through the first hydraulic element (thereby acting as a hydraulic turbine), and the power produced by the first hydraulic element may be provided to the HP spool via the high pressure geartrain. By contrast, if power is to be transferred from the HP spool to the HP spool, then the high pressure geartrain may provide power to the first hydraulic element, which may compress the hydraulic fluid within the hydraulic loop (thereby acting as a hydraulic compressor). The hydraulic fluid may then expand through the second hydraulic element (thereby acting as a hydraulic turbine), and the power produced by the second hydraulic element may be provided to the LP spool via the low pressure geartrain.

As shown in FIG. 15, a method 1400 of operating a gas turbine engine is provided. The gas turbine engine includes a high pressure spool coupled to a high pressure geartrain and a low pressure spool coupled to a low pressure geartrain. The high pressure geartrain and the low pressure geartrain may be coupled to a power transfer device.

The method 1400 includes at (1402) operating the gas turbine engine in a first operating condition. For example, the first operating condition may be one of a take off condition, a climb condition, and a cruise condition. In the take off condition, the gas turbine engine may be increasing speed and power to allow the aircraft to which it is attached to take off the ground. In the climb condition, the gas turbine engine may be operating at high power and speed to allow the aircraft to ascend. In the cruise conditions, the gas turbine engine may be at a steady speed to allow the aircraft to maintain altitude.

In various implementations, the method 1400 includes at (1404) providing power to an accessory (e.g., via one or more accessory drive gears in an accessory gearbox) with one of the high pressure geartrain or the low pressure geartrain during the first operating condition. Particularly, during the first operating condition, the method includes providing power to the accessory (e.g., via one or more accessory drive gears in the accessory gearbox) with the high pressure geartrain. For example, during the first operating condition, the method includes decoupling the low pressure geartrain from the accessory during the first operating condition by actuating a low pressure clutch connected to the low pressure geartrain, such that the high pressure geartrain provides power to the accessory during the first operating condition.

The method 1400 may further include at (1406) operating the gas turbine engine in a second operating condition that is different than the first operating condition. For example, the second operating condition may be one of a descent condition, a ground idle condition, and/or a taxi condition. In the descent condition, the gas turbine engine may be decelerating and/or may be operating such that the aircraft to which it is attached is descending. In the ground idle condition, the gas turbine engine may be operating at a low speed (e.g., much lower than climb or cruise conditions). In the taxi condition, the aircraft is pulled by a taxi vehicle, and the gas turbine engine may be slowing to a halt.

In many implementations, the method 1404 may further include at (1408) providing power to the accessory (e.g., via one or more accessory drive gears in the accessory gearbox) with the other of the high pressure geartrain or the low pressure geartrain during the second operating condition. Particularly, during the second operating condition, the method includes providing power to the accessory (e.g., via the one or more accessory drive gears in the accessory gearbox) with the low pressure geartrain. For example, during the second operating condition, the method includes decoupling the high pressure geartrain from the accessory during the second operating condition by actuating a high pressure clutch connected to the high pressure geartrain, such that the low pressure geartrain provides power to the accessory during the second operating condition.

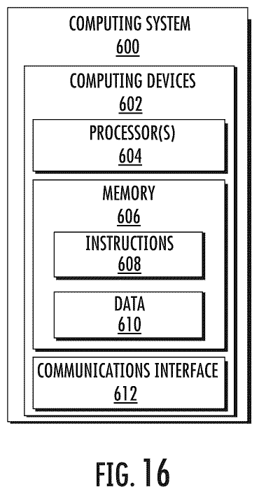

Referring now to FIG. 16, a block diagram of an example controller or computing system 600 is provided. The controller 600 can be used to implement the aspects disclosed herein. The controller 600 can include one or more computing device(s) 602. The controller 600 described above with reference to FIGS. 4 and 6-13 may be constructed and may operate in a same or similar manner as one of the controller 600 shown in FIG. 16, for example. The controller 600 may be utilized at least in part for implementing the methods 1300 and/or 1400 described above with reference to FIGS. 14 and 15.

As shown in FIG. 16, the one or more computing device(s) 602 can each include one or more processor(s) 604 and one or more memory device(s) 606. The one or more processor(s) 604 can include any suitable processing device, such as a microprocessor, microcontroller, integrated circuit, logic device, or other suitable processing device. The one or more memory device(s) 606 can include one or more computer-readable media, including, but not limited to, non-transitory computer-readable medium or media, RAM, ROM, hard drives, flash drives, and other memory devices, such as one or more buffer devices.

The one or more memory device(s) 606 can store information accessible by the one or more processor(s) 604, including computer-readable or computer-executable instructions 608 that can be executed by the one or more processor(s) 604. The instructions 608 can be any set of instructions or control logic that when executed by the one or more processor(s) 604, cause the one or more processor(s) 604 to perform operations. The instructions 608 can be software written in any suitable programming language or can be implemented in hardware.

The memory device(s) 606 can further store data 610 that can be accessed by the processor(s) 604. For example, the data 610 can include sensor data (such as engine parameters), model data, logic data, etc., as described herein. The data 610 can include one or more table(s), function(s), algorithm(s), model(s), equation(s), etc. according to example embodiments of the present disclosure.

The one or more computing device(s) 602 can also include a communication interface 612 used to communicate, for example, with the other components of the gas turbine engine. The communication interface 612 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects are provided by the subject matter of the following clauses:

A gas turbine engine comprising: a low pressure spool that connects a low pressure compressor to a low pressure turbine; a high pressure spool that connects a high pressure compressor to a high pressure turbine; a high pressure geartrain coupled in gear with the high pressure spool; and a low pressure geartrain coupled in gear with the low pressure spool, wherein the low pressure geartrain is coupled in gear with the low pressure spool and the high pressure geartrain is coupled in gear with the high pressure spool at a common axial location relative to a centerline axis of the gas turbine engine.

The gas turbine engine as in any preceding clause, further comprising a sump, wherein the high pressure geartrain and the low pressure geartrain are disposed at least partially in the sump.

The gas turbine engine as in any preceding clause, wherein the high pressure geartrain is circumferentially spaced apart from the low pressure geartrain.

The gas turbine engine as in any preceding clause, wherein the common axial location is axially between the low pressure compressor and the high pressure compressor.

The gas turbine engine as in any preceding clause, wherein the high pressure geartrain comprises a high pressure gear coupled in gear with the high pressure spool and a high pressure shaft extending from the high pressure gear, wherein the low pressure geartrain comprises a low pressure gear coupled in gear with to the low pressure spool and a low pressure shaft extending from the low pressure gear.

The gas turbine engine as in any preceding clause, wherein the gas turbine engine defines an air flowpath, wherein a plurality of struts extend through the air flowpath, wherein the low pressure shaft extends through a first strut of the plurality of struts, and wherein the high pressure shaft extends through a second strut of the plurality of struts.

The gas turbine engine as in any preceding clause, further comprising a bearing assembly disposed between the high pressure compressor and at least one of the high pressure geartrain and the low pressure geartrain.

The gas turbine engine as in any preceding clause, wherein the bearing assembly includes a low pressure bearing assembly proximate the low pressure compressor and a high pressure bearing assembly proximate the high pressure compressor, and wherein the high pressure geartrain and the low pressure geartrain are disposed proximate the high pressure bearing assembly.

A gas turbine engine comprising: a low pressure spool that connects a low pressure compressor to a low pressure turbine; a high pressure spool that connects a high pressure compressor to a high pressure turbine; a sump; a high pressure geartrain coupled in gear with the high pressure spool within the sump; and a low pressure geartrain coupled in gear with the low pressure spool within the sump.

The gas turbine engine as in any preceding clause, wherein the high pressure geartrain is circumferentially spaced apart from the low pressure geartrain.

The gas turbine engine as in any preceding clause, wherein the low pressure geartrain is coupled in gear with the low pressure spool and the high pressure geartrain is coupled in gear with the high pressure spool at a common axial location relative to a centerline axis of the gas turbine engine, and wherein the common axial location is axially between the low pressure compressor and the high pressure compressor.

The gas turbine engine as in any preceding clause, wherein the high pressure geartrain comprises a high pressure gear coupled in gear with the high pressure spool and a high pressure shaft extending from the high pressure gear, wherein the low pressure geartrain comprises a low pressure gear coupled in gear with the low pressure spool and a low pressure shaft extending from the low pressure gear.

The gas turbine engine as in any preceding clause, wherein the gas turbine engine defines an air flowpath, wherein a plurality of struts extends through the air flowpath, wherein the low pressure shaft extends through a first strut of the plurality of struts, and wherein the high pressure shaft extends through a second strut of the plurality of struts.

The gas turbine engine as in any preceding clause, further comprising a bearing assembly disposed between the high pressure compressor and at least one of the high pressure geartrain and the low pressure geartrain.

A gas turbine engine comprising: a low pressure spool that connects a low pressure compressor to a low pressure turbine; a high pressure spool that connects a high pressure compressor to a high pressure turbine; a high pressure geartrain coupled in gear with the high pressure spool; and a low pressure geartrain coupled in gear with the low pressure spool, wherein the high pressure geartrain is circumferentially spaced apart from the low pressure geartrain.

The gas turbine engine as in any preceding clause, further comprising a sump, wherein the high pressure geartrain and the low pressure geartrain are disposed in the sump.

The gas turbine engine as in any preceding clause, wherein the low pressure geartrain is coupled in gear with the low pressure spool and the high pressure geartrain is coupled in gear with the high pressure spool at a common axial location, and wherein the common axial location is axially between the low pressure compressor and the high pressure compressor.

The gas turbine engine as in any preceding clause, wherein the high pressure geartrain comprises a high pressure gear coupled in gear with the high pressure spool and a high pressure shaft extending from the high pressure gear, wherein the low pressure geartrain comprises a low pressure gear coupled in gear with the low pressure spool and a low pressure shaft extending from the low pressure gear.

The gas turbine engine as in any preceding clause, wherein the gas turbine engine defines an air flowpath, wherein a plurality of struts extends through the air flowpath, wherein the low pressure shaft extends through a first strut of the plurality of struts, and wherein the high pressure shaft extends through a second strut of the plurality of struts.

The gas turbine engine as in any preceding clause, further comprising a bearing assembly disposed between the high pressure compressor and at least one of the high pressure geartrain and the low pressure geartrain.

A gas turbine engine comprising: a low pressure spool that connects a low pressure compressor to a low pressure turbine; a high pressure spool that connects a high pressure compressor to a high pressure turbine; a high pressure geartrain coupled in gear with the high pressure spool; a low pressure geartrain coupled in gear with the low pressure spool; and a power transfer device coupling the high pressure geartrain and the low pressure geartrain to transfer power between the high pressure spool and the low pressure spool.

The gas turbine engine as in any preceding clause, wherein the power transfer device comprises a continuously variable transmission (CVT).

The gas turbine engine as in any preceding clause, wherein the CVT comprises a first shaft coupled the low pressure geartrain and a second shaft coupled to the high pressure geartrain.

The gas turbine engine as in any preceding clause, wherein the CVT comprises an input disc coupled to the first shaft, an output disc coupled to the second shaft, and one or more roller assemblies disposed between the input disc and the output disc.

The gas turbine engine as in any preceding clause, wherein the power transfer device is a pneumatic system having a pneumatic compressor coupled in gear with one of the high pressure geartrain or the low pressure geartrain and a pneumatic turbine coupled in gear with the other of the high pressure geartrain or the low pressure geartrain.

The gas turbine engine as in any preceding clause, wherein the pneumatic compressor is fluidly connected to an air supply, wherein air from the air supply is to be pressurized by the pneumatic compressor and provided to the pneumatic turbine.

The gas turbine engine as in any preceding clause, wherein the air supply includes one of bypass air from a bypass airflow passage of the gas turbine engine and bleed air from one of the high pressure compressor and the low pressure compressor.

The gas turbine engine as in any preceding clause, wherein the pneumatic system further comprises a recirculation line extending between the pneumatic turbine and the pneumatic compressor.

The gas turbine engine as in any preceding clause, wherein the power transfer device is a hydraulic system having a first hydraulic element coupled to high pressure geartrain the and a second hydraulic element coupled to the low pressure geartrain.

The gas turbine engine as in any preceding clause, wherein the first hydraulic element and the second hydraulic element are disposed on a hydraulic loop and are interchangeably operable as both a hydraulic compressor and a hydraulic turbine.

The gas turbine engine as in any preceding clause, wherein a heat exchanger is disposed in thermal communication on the hydraulic loop.

The gas turbine engine as in any preceding clause, wherein the power transferring device comprises a gearbox transmission having a first shaft connected to the low pressure geartrain and a second shaft connected to the high pressure geartrain.

The gas turbine engine as in any preceding clause, further comprising a first clutch coupled to the first shaft and a second clutch coupled to the second shaft, wherein the first clutch is to selectively decouple the low pressure geartrain from the gearbox transmission, and wherein the second clutch is to selectively decouple the high pressure geartrain from the gearbox transmission.

The gas turbine engine as in any preceding clause, wherein the high pressure geartrain comprises a high pressure gear rotatably coupled to the high pressure spool and a high pressure shaft extending from the high pressure gear, wherein the low pressure geartrain comprises a low pressure gear rotatably coupled to the low pressure spool and a low pressure shaft extending from the low pressure gear.

A method of operating a gas turbine engine, the gas turbine engine comprising a high pressure spool coupled to a high pressure geartrain and a low pressure spool coupled to a low pressure geartrain, the high pressure geartrain and the low pressure geartrain coupled to a power transfer device, the method comprising: operating the gas turbine engine in a first operating condition; transferring power from the high pressure spool to the low pressure spool via the power transfer device during the first operating condition; operating the gas turbine engine in a second operating condition that is different than the first operating condition; and transferring power from the low pressure spool to the high pressure spool via the power transfer device during the second operating condition.

The method as in any preceding clause, wherein the first operating condition is one of a take off condition, a climb condition, and a cruise condition.

The method as in any preceding clause, wherein the second operating condition is one of a descent condition, a ground idle condition, and a taxi condition.

The method as in any preceding clause, wherein the power transfer device comprises a continuous variable transmission (CVT), and wherein the method further comprises transferring power between the high pressure spool and the low pressure spool via the CVT.

The method as in any preceding clause, wherein the CVT comprises an input disc coupled to a first shaft, an output disc coupled to a second shaft, and one or more roller assemblies disposed between the input disc and the output disc, and wherein the method comprises:
actuating the one or more roller assemblies to adjust an amount of power transferred between the high pressure spool and the low pressure spool.

The method as in any preceding clause, wherein the power transfer device comprises a hydraulic system having a first hydraulic element coupled to high pressure geartrain the and a second hydraulic element coupled to the low pressure geartrain, and wherein the method further comprises transferring power between the low pressure spool and the high pressure spool via the hydraulic system.

A gas turbine engine comprising: a low pressure spool that connects a low pressure compressor to a low pressure turbine; a high pressure spool that connects a high pressure compressor to a high pressure turbine; a high pressure geartrain coupled in gear with the high pressure spool; a low pressure geartrain coupled in gear with the low pressure spool; and an accessory gearbox having an accessory drive gear that is selectively drivingly coupled to at least one of the high pressure geartrain and the low pressure geartrain.

The gas turbine engine as in any preceding clause, wherein the accessory drive gear is selectively drivingly coupled to both of the high pressure geartrain and the low pressure geartrain.

The gas turbine engine as in any preceding clause, wherein the high pressure geartrain includes a high pressure clutch for selectively decoupling the high pressure geartrain from the accessory gearbox, and wherein the low pressure geartrain includes a low pressure clutch for selectively decoupling the low pressure geartrain from the accessory gearbox.

The gas turbine engine as in any preceding clause, wherein the accessory drive gear is selectively driven by one of the high pressure geartrain in a first operating condition and the low pressure geartrain in a second operating condition, wherein in the first operating condition the high pressure clutch is in an engaged position and the low pressure clutch is in a disengaged position such that the accessory drive gear is powered by the high pressure geartrain, and wherein in the second operating condition the high pressure clutch is in the disengaged position and the low pressure clutch is in the engaged position such that the accessory drive gear is powered by the low pressure geartrain.

The gas turbine engine as in any preceding clause, wherein the low pressure spool and the high pressure spool are counter rotating, and wherein the gas turbine engine further comprises a reversing gear disposed between the accessory drive gear and one of the low pressure geartrain or the high pressure geartrain.

The gas turbine engine as in any preceding clause, wherein the high pressure geartrain includes a high pressure output gear, and wherein the low pressure geartrain includes a low pressure output gear.

The gas turbine engine as in any preceding clause, further comprising a continuous variable transmission (CVT) having first shaft coupled to the low pressure output gear and a second shaft coupled to the high pressure output gear, wherein the high pressure output gear is coupled to the accessory drive gear.

The gas turbine as in any preceding clause, wherein the accessory gearbox comprises a gearbox housing, and wherein the high pressure output gear, the low pressure output gear, the accessory drive gear, and the CVT are disposed within the gearbox housing.

The gas turbine engine as in any preceding clause, further comprising a continuous variable transmission (CVT) having a first shaft coupled to the accessory drive gear and a second shaft coupled to an accessory.

The gas turbine engine as in any preceding clause, wherein the accessory is one of an environmental control system (ECS) compressor, a fuel pump, a lubrication pump, and a generator.

The gas turbine engine as in any preceding clause, wherein the accessory gearbox includes a first group of accessory drive gears driven by the low pressure geartrain and a second group of accessory drive gears driven by the high pressure geartrain.

The gas turbine engine as in any preceding clause, wherein the low pressure geartrain and the high pressure geartrain are mechanically isolated from one another.

The gas turbine engine as in any preceding clause, wherein at least one accessory drive gear in the second group of accessory drive gears is coupled to an input shaft of an air turbine starter (ATS).

The gas turbine as in any preceding clause, wherein the ATS includes an ATS clutch for selectively decoupling the ATS from the high pressure geartrain.

The gas turbine as in any preceding clause, wherein the high pressure geartrain only powers the ATS.

A method of operating a gas turbine engine, the gas turbine engine comprising a high pressure spool coupled to a high pressure geartrain and a low pressure spool coupled to a low pressure geartrain, the method comprising: operating the gas turbine engine in a first operating condition; providing power to an accessory with one of the high pressure geartrain or the low pressure geartrain during the first operating condition; operating the gas turbine engine in a second operating condition that is different than the first operating condition; and providing power to the accessory with the other of the high pressure geartrain or the low pressure geartrain during the second operating condition.

The method as in any preceding clause, wherein the first operating condition is one of a take off condition, a climb condition, and a cruise condition, and wherein the method comprises providing power to the accessory with the high pressure geartrain.

The method as in any preceding clause, further comprising: decoupling the low pressure geartrain from accessory during the first operating condition by actuating a low pressure clutch connected to the low pressure geartrain.

The method as in any preceding clause, the second operating condition is one of a descent condition, a ground idle condition, and a taxi condition, and wherein the method comprises providing power to the accessory with the low pressure geartrain.

The method as in any preceding clause, further comprising: decoupling the high pressure geartrain from the accessory during the second operating condition by actuating a high pressure clutch connected to the high pressure geartrain.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine comprising:
a low pressure spool that connects a low pressure compressor to a low pressure turbine;
a high pressure spool that connects a high pressure compressor to a high pressure turbine;
a high pressure geartrain coupled in gear with the high pressure spool;
a low pressure geartrain coupled in gear with the low pressure spool; and
an accessory gearbox having an accessory drive gear that is selectively drivingly coupled to at least one of the high pressure geartrain and the low pressure geartrain.

2. The gas turbine engine as in claim 1, wherein the accessory drive gear is selectively drivingly coupled to both of the high pressure geartrain and the low pressure geartrain.

3. The gas turbine engine as in claim 2, wherein the high pressure geartrain includes a high pressure clutch for selectively decoupling the high pressure geartrain from the accessory gearbox, and wherein the low pressure geartrain includes a low pressure clutch for selectively decoupling the low pressure geartrain from the accessory gearbox.

4. The gas turbine engine as in claim 3, wherein the accessory drive gear is selectively driven by one of the high pressure geartrain in a first operating condition and the low pressure geartrain in a second operating condition, wherein in the first operating condition the high pressure clutch is in an engaged position and the low pressure clutch is in a disengaged position such that the accessory drive gear is powered by the high pressure geartrain, and wherein in the second operating condition the high pressure clutch is in the disengaged position and the low pressure clutch is in the engaged position such that the accessory drive gear is powered by the low pressure geartrain.

5. The gas turbine engine as in claim 1, wherein the low pressure spool and the high pressure spool are counter rotating, and wherein the gas turbine engine further comprises a reversing gear disposed between the accessory drive gear and one of the low pressure geartrain or the high pressure geartrain.

6. The gas turbine engine as in claim 1, wherein the high pressure geartrain includes a high pressure output gear, and wherein the low pressure geartrain includes a low pressure output gear.

7. The gas turbine engine as in claim 6, further comprising a continuous variable transmission (CVT) having first shaft coupled to the low pressure output gear and a second shaft coupled to the high pressure output gear, wherein the high pressure output gear is coupled to the accessory drive gear.

8. The gas turbine as in claim 7, wherein the accessory gearbox comprises a gearbox housing, and wherein the high pressure output gear, the low pressure output gear, the accessory drive gear, and the CVT are disposed within the gearbox housing.

9. The gas turbine engine as in claim 1, further comprising a continuous variable transmission (CVT) having a first shaft coupled to the accessory drive gear and a second shaft coupled to an accessory.

10. The gas turbine engine as in claim 9, wherein the accessory is one of an environmental control system (ECS) compressor, a fuel pump, a lubrication pump, and a generator.

11. The gas turbine engine as in claim 1, wherein the accessory gearbox includes a first group of accessory drive gears driven by the low pressure geartrain and a second group of accessory drive gears driven by the high pressure geartrain.

12. The gas turbine engine as in claim 11, wherein the low pressure geartrain and the high pressure geartrain are mechanically isolated from one another.

13. The gas turbine engine as in claim 11, wherein at least one accessory drive gear in the second group of accessory drive gears is coupled to an input shaft of an air turbine starter (ATS).

14. The gas turbine as in claim 13, wherein the ATS includes an ATS clutch for selectively decoupling the ATS from the high pressure geartrain.

15. The gas turbine as in claim 13, wherein the high pressure geartrain only powers the ATS.

16. A method of operating a gas turbine engine, the gas turbine engine comprising a high pressure spool coupled to a high pressure geartrain and a low pressure spool coupled to a low pressure geartrain, the method comprising:
operating the gas turbine engine in a first operating condition;
providing power to an accessory with one of the high pressure geartrain or the low pressure geartrain during the first operating condition;
operating the gas turbine engine in a second operating condition that is different than the first operating condition; and
providing power to the accessory with the other of the high pressure geartrain or the low pressure geartrain during the second operating condition.

17. The method as in claim 16, wherein the first operating condition is one of a take off condition, a climb condition, and a cruise condition, and wherein the method comprises providing power to the accessory with the high pressure geartrain.

18. The method as in claim 17, further comprising:
decoupling the low pressure geartrain from accessory during the first operating condition by actuating a low pressure clutch connected to the low pressure geartrain.

19. The method as in claim 16, the second operating condition is one of a descent condition, a ground idle condition, and a taxi condition, and wherein the method comprises providing power to the accessory with the low pressure geartrain.

20. The method as in claim 19, further comprising:
decoupling the high pressure geartrain from the accessory during the second operating condition by actuating a high pressure clutch connected to the high pressure geartrain.
